(19) United States
(12) Patent Application Publication
(10) Pub. No.: US 2005/0022745 A1
(43) Pub. Date: Feb. 3, 2005

(54) Electroless plating method, electroless plating device, and production method and production device of semiconductor device

(75) Inventors: Hiroshi Nakano, Hitachi (JP); Takeyuki Itabashi, Hitachi (JP); Haruo Akahoshi, Hitachi (JP)

Correspondence Address: McDermott, Will & Emery, 600, 13th Street, N.W., Washington, DC, 20005-3096, US

(73) Assignee: HITACHI, LTD.

(21) Appl. No.: 10/898,201

(22) Filed: Jul. 26, 2004

(30) Foreign Application Priority Data
Jul. 30, 2003 (JP) 2003-203788

(51) Int. Cl. B05D 1/18

(52) U.S. Cl. 118/728; 427/443.1

(57) ABSTRACT

The invention is purposed to reduce the amount of the electroless plating solution used for plating, to facilitate compositional control of the plating solution, and to prevent degradation of quality of the plating film (deposit) by oxygen dissolved in the plating solution. An electroless plating method in which a previously prepared electroless plating solution is exposed to a depressurized atmosphere to decrease the gas components existing in the solution, and while maintaining the plating solution in the form of a continuous thin layer, the surface to be plated of the substrate on which to form an electroless plating film is brought into contact with said layer of the plating solution and maintained in this state for a required period of time to perform electroless plating. An electroless plating device, and a production method and a production device of semiconductor devices are also disclosed.

### FIELD OF THE INVENTION

The present invention relates to an electroless plating method, an electroless plating device, and a production method and a production device of semiconductor devices. More particularly, it relates to electroless plating techniques available for producing electronic devices such as semiconductor devices having a basic structure comprising a wiring system using copper or the like as wiring material and having an interconnect protective film.

### BACKGROUND OF THE INVENTION

Request is rising for the improvement of operating speed of semiconductor devices for realizing a higher degree of integration and higher performance of the semiconductor devices, and in line with this, efforts have been made for further miniaturization and layer multiplication of internal wiring of LSI. Such miniaturization and layer multiplication of wiring system lead to an increase of wiring resistance and inter-wiring capacitance, which affects interconnecting signal transfer speed. Since this signal transfer delay time encumbers speed-up of operation of semiconductor devices, it has been tried to lower dielectric constant of the interlayer insulating films for controlling the inter-wiring capacitance and to lower resistance of the wiring material to reduce wiring resistance, thereby to elevate operation speed.

It has been proposed to use copper, whose specific resistance is as low as 1.7 μΩ·cm, as wiring material. But this material has the problem that it is liable to oxidize on the surface to cause an increase of wiring resistance or lower reliability of wiring or elements. Also, copper tends to react with the insulating films or diffuse into these films, so that in order to secure reliability of interconnection, it needs to provide a protective film between copper interconnect and insulating films, but formation of a conductive film as an interconnect protective film on the surface of wiring enables a reduction of electric capacity.

As means for forming the interconnect protective films, there are known methods making use of electroless plating for forming the conductive films. For instance, U.S. Pat. No. 5,695,810 (CLAIMS) shows the idea of forming a cobalt-tungsten-phosphorus conductive film as an interconnect protective film by electroless plating. Also, JP-A-2002-151518 (abstract) discloses means of forming a cobalt-tungsten-boron conductive film.

As the method of such electroless plating, JP-A-2001-342573 (abstract) and JP-A-2002-129343 (abstract) propose application of an electroless plating solution by circulation. In this method, however, since the plating solution is kept dropped onto the surface to be plated of a semiconductor substrate throughout the process, the plating solution is used in large quantities for circulation. Further, in such use of the plating solution by circulation, fine particles tend to be generated from the component parts of the apparatus, and such generation of fine particles may become a momentum to start decomposition of the plating solution, causing deposition of fine particles on the semiconductor substrate to lower reliability of wiring.

Further, the electroless plating solution has the property that its concentration varies in accordance with the progress of reaction, so that the formed film composition changes with variation of the solution composition, resulting in loss of the normal function of the film to protect the wiring. Moreover, in order to maintain the solution composition, scale-up of the apparatus becomes essential because of the necessity of incorporating a compositional analyzer, replenishing means, etc., making it difficult to form a functional film with high reproducibility.

In the method of JP-A-2002-129343 (abstract), in order to save the amount of the plating solution used, plating is carried out by placing the plating solution on rotary wafer holder surface, but since the semiconductor substrate is not in a state of being sealed airtight, air is taken in to increase the amount of oxygen staying dissolved in the plating solution. It has been confirmed that the presence of such dissolved oxygen has the effect of retarding the progress of plating reaction, adversely affecting the in-plane uniformity of the film thickness.

JP-A-2001-342573 (abstract) discloses a method in which the electroless plating solution is sprayed from the shower head on the upwardly disposed surface to be plated of the substrate, but this method involves the same problem as encountered in JP-A-2002-129343 (abstract) since the plating solution is brought into contact with air to take in oxygen.

### SUMMARY OF THE INVENTION

As explained above, in order to form a continuous functional film by an electroless plating device which has been used for forming the interconnect protective films, the plating solution is used in circulation, so that analytical control of the plating solution is necessary, and because of the large volume of the solution used, scale-up of the equipment is indispensable, inviting a rise of running cost. Researches have been made for a plating film forming method that can solve these problems, but there is yet known no electroless plating method and device that can meet the said film forming conditions.

An object of the present invention is to form films, typically interconnect protective films, with high uniformity by easy control of the plating solution, and to provide therefor an electroless plating method, an electroless plating device, and a production method and a production device of semiconductor devices.

According to the present invention, there is provided an electroless plating method comprising the step of carrying out an electroless plating treatment by, while keeping an electroless plating solution beforehand prepared at a continuous thin liquid layer, bringing a surface to be plated of a substrate, on which an electroless plating is to be formed, into contact with the liquid layer and by maintaining the contacting state for a prescribed period of time. The above electroless plating treatment is conducted on each of the substrates piece by piece, and an amount of the electroless plating solution used per substrate is preferably 5 to 150 ml. Particularly a good plating film can be obtained by carrying out the above electroless plating treatment by exposing the electroless plating solution to a depressurized atmosphere to decrease gaseous components staying dissolved in the solution.

The electroless plating solution, at least in a region where the electroless plating is to be carried out, is preferably kept in a substantially closed atmosphere shut off from an outer air. This makes it possible to prevent air, especially oxygen, from getting into the plating solution to impair the progress of plating. Any of the above four patent documents are silent on the conception of shutting off the plating atmosphere from the outer air. In order to create such an inert atmosphere, it is preferable to maintain the layer of said plating solution in a non-oxidative atmosphere, for instance, a nitrogen or argon atmosphere.

It is a practical and simple way of embodying the method of the present invention that the liquid layer of the solution is substantially kept horizontally and a downwardly facing surface to be plated of the substrate is brought into contact with the surface of the plating solution.

A principal example of application of the present invention is forming an interconnect protective film for a semiconductor device. The substrate surface to be plated has a copper interconnect, and an interconnect protective film is formed on said copper interconnect by the electroless plating. Currently, in the production of semiconductor devices, it is the most popular practice in the art to work e.g. 12-inch (about 30 cm in diameter) wafers one by one, with this operation being called “leaf processing”. Formation of the interconnect protective film by electroless plating is also included in this leaf processing. The present invention is especially suited for this leaf processing, and the “surface to be plated” referred to in this specification means a surface of each unit wafer.

In the present invention, at least during the electroless plating treatment, an opening of a container forming the layer of the electroless plating solution is closed by the surface to be plated of the substrate. This is helpful to protect the rear side of the semiconductor substrate from the plating solution when it is desired not to contaminate the rear side of the substrate with the plating solution or other matter. It also keeps the plating solution free from oxygen.

The present invention is purposed to form the films with a very small thickness of tens to hundreds nm such as interconnect protective films for semiconductor devices. For the adjustment of solution composition, temperature control, temperature management and cost reduction, it is necessary to minimize the volume of the plating solution used for one piece of wafer. For this reason, the electroless plating liquid layer thickness is confined to a range of 0.01 to 5 mm. Especially a layer thickness in the range of around 0.1 to 1 mm is optimum. The smaller the volume of the plating solution, the easier the temperature control. Control of the plating solution composition, for example, correct adjustment of the plating solution composition during the plating operation, is by no means easy. According to the present invention, by minimizing the amount of the plating solution used per wafer, control of the plating solution composition during the plating operation is made unnecessary and the plating solution is discarded on the conclusion of every plating operation without compositional adjustment of the plating solution, so that control of the plating solution is strikingly simplified and also cost of the plating solution (material cost, control cost, etc.) is greatly reduced.

In the present invention, it is preferable to stop a flow of the electroless plating solution during the electroless plating treatment. In the conventional electroless plating process, it has been the common practice to adjust the plating solution composition or to stir or circulate the plating solution during the plating operation. According to such practice, however, it becomes necessary to control the plating solution composition and there is a possibility to take in oxygen to cause troubles.

The present invention provides an electroless plating device comprising: an electroless plating treatment container having an opening and forming a continuous thin liquid layer of electroless plating solution; a first plating solution supply means comprising a pump and piping for feeding the electroless plating solution to said container; and a second plating solution supply means comprising a pump and piping for lowering a gas in the plating solution during the electroless plating treatment.

An internal capacity of said plating container is preferably 5 to 150 ml, the optimal volume being around 30 to 50 ml, in case where 12-inch wafers are treated. As mentioned above, the opening of the plating container and the substrate to be plated are preferably designed such that the area of said opening of the container be smaller than the area of the surface to be plated of the substrate, and that said opening be closed by the substrate.

As mentioned above, it is preferable to form a continuous thin layer of electroless plating solution between the bottom of said plating container and the surface to be plated of the substrate. No good plating film can be obtained with a discontinuous or non-uniform layer of plating solution. The distance between the surface to be plated of the substrate and a bottom side of the electroless plating treatment container is preferably 0.01 to 5 mm.

Means are provided for keeping the thin layer of electroless plating solution substantially horizontally and for holding the surface to be plated of the substrate in a downwardly facing position to contact the thin layer of plating solution. This ensures contact between the plating solution and the surface to be plated of the substrate, making it possible to obtain a good plating film.

In accordance with the present invention, there is also provided an electroless plating in which in addition to a tank of the electroless plating solution tank, there is provided at least one kind of treating solution tank. This plating device is preferably provided with a gas supply pipe for substituting a plating space with an inert gas atmosphere lowered in oxygen concentration.

The present invention is further intended to provide a device for producing a semiconductor device comprising: means for setting a region, at which an interconnect protective film on a semiconductor substrate having a metal interconnect is to be formed, and for holding said semiconductor substrate so as to being said region of the substrate into contact with a thin layer of an electroless plating solution beforehand prepared; a degassing means for degassing the plating solution to decrease gas components therein; and a closure means for shutting off an atmosphere of the electroless plating solution from an outer air.

According to the present invention, control of the electroless plating solution becomes easy and also the electroless plating conditions can be set with good reproducibility, making it possible to realize a further dimensional reduction of the electroless plating device and to attain the object to prevent rise of running cost. Further, reproducibility of the formed interconnect protective film composition and uniformity of the worked wafers are improved to elevate reliability of semiconductor interconnect.

Other objects, features and advantages of the invention will become apparent from the following description of the embodiments of the invention taken in conjunction with the accompanying drawings.

### BRIEF DESCRIPTION OF THE DRAWINGS

FIG. 1 is a flow chart illustrating a process of forming an interconnect protective film for a semiconductor device.

FIG. 2 is a schematic plan showing the general layout of an electroless plating device according to another embodiment of the present invention.

FIG. 3 is a plan for illustrating a principal part of the electroless plating device of the present invention.

FIG. 4 is a cross-sectional view showing the structure of a principal part of the electroless plating device of the present invention.

FIG. 5 is a plan, partly shown in section, showing the structure of the electroless plating device according to the first embodiment of the present invention.

FIG. 6 is a side elevation, partly shown in section, showing the structure of the electroless plating device according to the third embodiment of the present invention.

FIG. 7 is a schematic diagram of the plating system in the semiconductor producing device in an embodiment of the present invention.

FIG. 8 is a schematic diagram of the plating system in the semiconductor producing device in another embodiment of the present invention.

FIG. 9 is a cross-sectional view showing arrangement of semiconductor, insulating film, wiring film and protective film of a semiconductor device to which the present invention was applied.

FIG. 10 is a plan showing the plane structure of a semiconductor device to which the present invention was applied.

### DESCRIPTION OF REFERENCE NUMERALS

1: interconnect protective film, 2: copper interconnect, 3: barrier film, 4: insulating film, 5: seed layer, 6: copper film, 7: groove for wiring, 8: SiN interconnect protective film, 9: palladium film, 10: connecting hole, 11: wiring plug, 12: wiring oxidized layer, 13: abnormal deposition, 14: inter-wiring shorting.

### DETAILED DESCRIPTION OF THE INVENTION

The semiconductor producing device according to the present invention and its preferred embodiments are explained below.

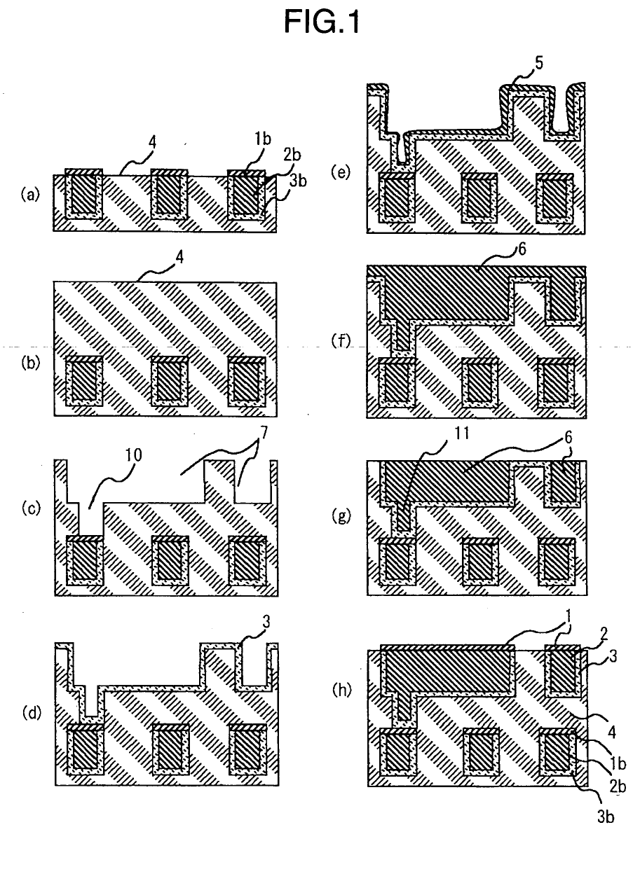

A semiconductor device is produced from a process comprising the following steps (a) to (g):
(a) An insulating film 4 is formed on a semiconductor substrate (here, a sublayer wiring layer already having an insulating film 3b and sublayer wiring 2b formed on the inside surface of each groove as shown in FIG. 1(a) is used as substrate), and a barrier film 3b and wiring material 2b are formed by sputtering in each groove formed in said insulating film. (FIG. 1(b)).
(b) Wiring grooves 7 and connecting holes 10 are formed in the insulating film 4. (FIG. 1(c)).
(c) Barrier film 3 for preventing diffusion of wiring material is formed on insulating film 4. (FIG. 1(d)).
(d) Seed layer 5 which becomes ground for electrolytic copper plating is formed on barrier film 3 (FIG. 1(e)).
(e) Wiring grooves 7 and holes 10 are filled up with copper 6 by electrolytic copper plating on copper seed layer 5. (FIG. 1(f)).
(f) The film of copper 6 formed on barrier film 3 excluding grooves 7 and holes 10 is removed so that copper 6 is left only in the inside of each groove 7 and hole 10 to form wiring 2 and wiring plug 11. (FIG. 1(g)).
(g) Interconnect protective film 1 is formed only on the surface of wiring 2 and wiring plug 11 by electroless plating. (FIG. 1(h)).

The above steps (a) to (g) are repeated a necessary number of times to form a semiconductor device having multiple laminated wiring layers. Any of the steps (a) to (f) can be carried out in the same way as the conventional wiring forming process, and the conventional materials can be used for the substrate and insulating film.

For instance, as the substrate, it is possible to use one comprising a silicon wafer such as used in the conventional LSI process, with elements formed thereon, or a wafer having sublayer wiring 2b formed thereon as described above. Also, as the insulating film 4 formed in step (a), there can be used the known insulating materials such as SiO₂, silsesquioxane hydride (SiOF) and methylsiloxane, various kinds of low dielectric constant materials and their laminate films. (FIG. 1(b)).

Conventional lithographic and etching techniques can be employed for forming wiring grooves 7 and holes 10 in step (b). (FIG. 1(c)).

As barrier film 3 formed in step (c), it is possible to use a film made of a known high-melting point material such as titanium, tantalum, tungsten, etc., or their alloys, or a nitride film made of titanium nitride, tantalum nitride, tungsten nitride or such. These films can be formed by the known techniques such as chemical vapor growth and sputtering. (FIG. 1(d)).

The known techniques such as chemical vapor growth and sputtering can be used for forming seed layer 5 in step (d). (FIG. 1(e)).

In step (e), copper film 6 is formed by electroplating. (FIG. 1(f)).

In step (f), copper and barrier film at the unnecessary parts are removed by chemical machine grinding. (FIG. 1(g)).

The step of forming interconnect protective film 1 by electroless plating on the surfaces of grooves 7 and holes 10 (wiring 2 and wiring plug 11) formed in step (g) is a step characteristic of the present invention. This step is carried out by dipping the chemical machine ground substrate in an electroless plating bath. As electroless plating, cobalt-based plating with high thermal stability is suited.

The cobalt-based electroless plating bath is composed of a metal salt, a reducing agent, a complexing agent, a pH adjuster and other additives. As cobalt salt, cobalt sulfate, cobalt chloride and the like can be used. As tungsten salt, ammonium tungstate, tungstic acid and the like can be used.

As reducing agent, in order to form an interconnect protective film selectively on copper interconnect alone, the boron compounds which can react on the copper interconnect surface and the cobalt plating film are preferably used. Examples of such boron compounds are dimethylamineborane, diethylamineborane, almineborane and sodium hydride. Use of such a reducing agent makes it possible to form an interconnect protective film directly on copper interconnect without needing a plating catalyst such as palladium. Ammonium, tetramethylammonium and the like are preferably used as alkali solution for pH adjustment.

Citrates and the like are suited for use as completing agent. As additives, thiourea, saccharine, thioglycollic acid, known surfactants, etc., can be used. The plating solution temperature is preferably in the range from 40° C. to 90° C. In case of using hypophosphorous acid or hypophosphite as reducing agent, it is necessary to apply a catalytic treatment with Pd on the surface of Cu wiring before conducting electroless plating.

As the material of the film to be formed, tungsten-based and molybdenum-based alloys such as cobalt-tungsten-boron alloy and cobalt-tungsten-phosphorus alloy are preferably used. It is advisable to add a pretreatment step of cleaning wafers before conducting electroless plating. This can eliminate the influences such as variation of plating speed by contamination of the copper interconnect surface or deposition of organic matter, affording an improvement of film thickness uniformity in the wafer plane.

As the pretreatment solution, it is recommendable to use an acidic solution such as sulfuric acid diluted to about 5%, an alkaline solution such as organic alkali, or a reducing solution which can reduce the copper surface. The acidic solution has the effect of dissolving oxides on the copper interconnect surface but has the risk of enlarging surface unevenness, so that the treatment should be completed in a short time. The reducing solution has the effect of reducing oxides on the copper surface and is capable of enhancing activity of the copper surface while maintaining the surface unevenness, so that it is suited for the pretreatment.

As the reducing pretreatment solution, it is advisable to use a solution prepared by mixing appropriate amounts of a complexing agent such as citric acid or succinic acid, a boron compound such as dimethylamineborane, a copper reducing agent, e.g. aldehydes such as formaldehyde, an organic alkali agent such as aqueous tetramethylammonium solution for pH adjustment, and additives such as surfactant. Treating temperature is preferably 20 to 70° C., more preferably 40 to 60° C. pH is adjusted to stay in the range from neutrality to 12.

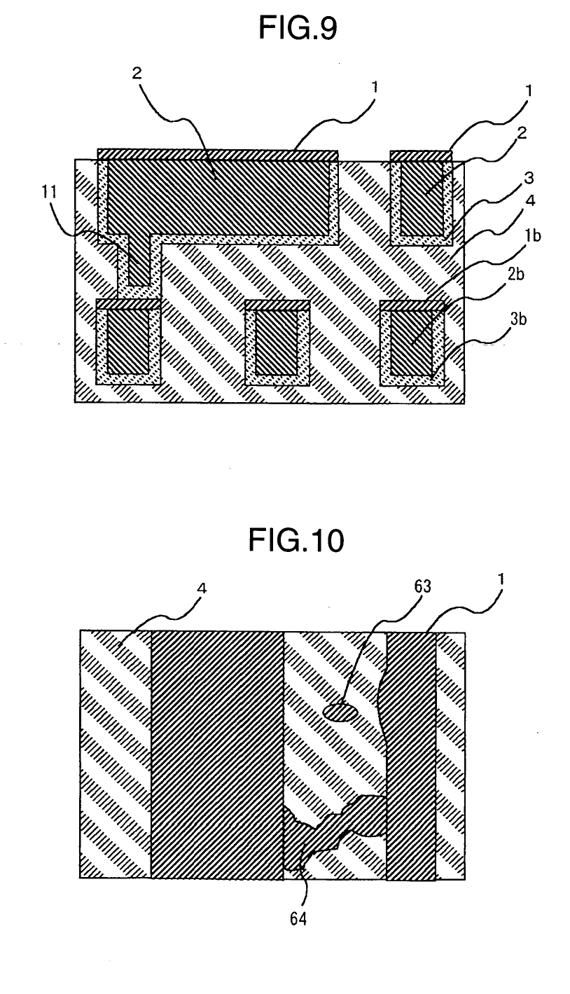

The interconnect protective film 1 formed by using a cobalt-based electroless plating bath as described above selectively covers copper interconnect 2 as exemplified in FIG. 9. Since interconnect protective film 1 selectively covering copper interconnect 2 grows isotropically from copper interconnect, it is not only formed just above copper interconnect but extends onto the barrier film or insulating film from the edge of copper interconnect equally to the desired thickness of the interconnect protective film. In FIG. 9, the same reference numerals as used in FIG. 1 designate the same elements.

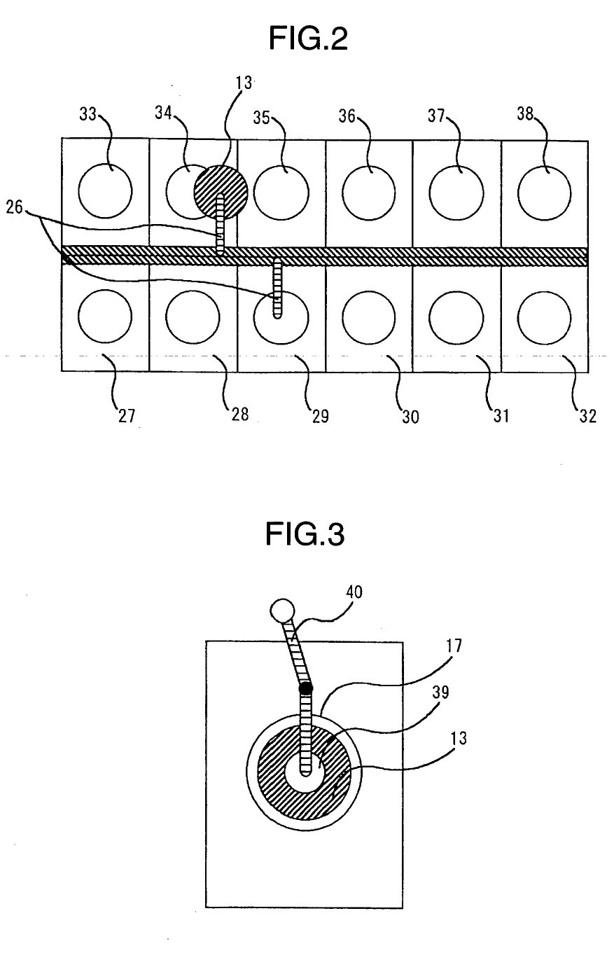

The system for carrying out such cobalt-based electroless plating will be explained concretely in relation to the semiconductor device producing device and chemical solution treating device (particularly plating device) used in the respective Examples, with reference to FIG. 2.

A. Structure of Plating Device

As an example of the plating device incorporated in the semiconductor device manufacturing apparatus of the present invention, the automatic wafer plating device used in the Examples described below is here illustrated.

The main body of the automatic wafer plating device used in the Examples comprises, as shown in FIG. 2, a conveyor mechanism (conveyor robots) 26 for conveying wafers 13, loading stage 27, pre-plating stage 28, plating stage 29, cleaning stage 30, drying stage 31 and unloading stage 32. There are also provided a chemical solution supply system and a chemical solution recovering system (not shown).

There are provided wafer cassette 33 at loading stage 27, plating pretreatment solution tank 34 at pre-plating stage 28, plating solution tank 35 at plating stage 29, cleaning tank 36 at cleaning stage 30, dryer 37 at drying stage 31, and wafer cassette 38 at unloading stage 32. Plating pretreatment solution tank 34 and plating solution tank 35 are the tanks in which treatment with a chemical solution is conducted. Each of these tanks is equipped with piping for supplying a chemical solution and a temperature controller (not shown). Spinner treatment may be conducted in cleaning tank 36.

Each of these stages 27-32 may be provided in plurality for improving throughput capacity. Pre-plating stage 28 and cleaning stage 30 may be excluded. Particularly in the case of cobalt-based electroless plating using a boron compound such as dimethyl-amineborane as reducing agent, the pre-treating stage can be excluded as catalyzation of Pd, etc., is unnecessary. Conveyor robot 26, as shown in FIG. 3, has a wafer carrier arm 40 and a wafer holder 39, and is designed to hold wafer 13 and carry it to a predetermined position (for example, chemical solution treating tank 17).

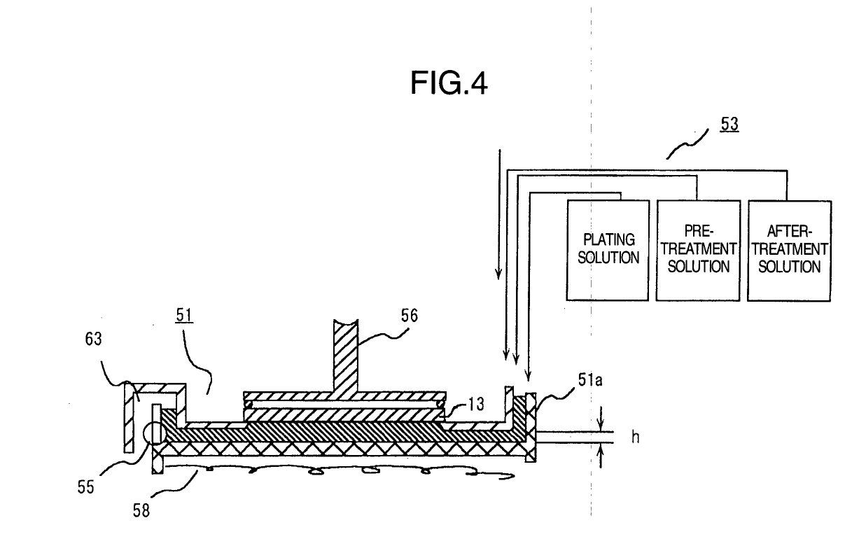

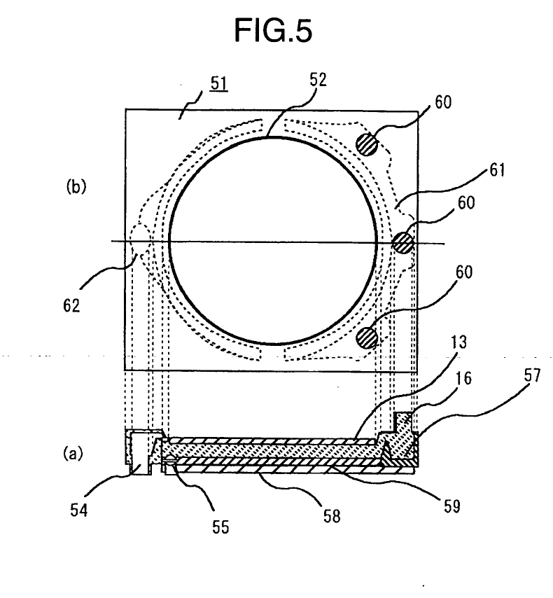

The chemical solution treating tank 17 of the automatic wafer plating device in this example may be of a mechanism such as shown in FIG. 4 and FIGS. 5(a) and (b). FIG. 5(a) is a cross section of treating tank 51, and FIG. 5(b) is a top plan thereof. This treating tank 51 is provided with a wafer support 52 along the top opening of a thin saucer-like container 51a, and at a position opposing the side of said support 52 is provided a chemical solution supply line 53 which passes into the inside of treating tank 51 from its outside. The chemical solution supplied from its supply line 53 is discharged out of treating tank 5 from chemical solution discharge port 54 via valve 55. The surface to be treated of wafer 13 carried on support 52 and fixed in position by wafer holder 56 is brought into contact with the layer 57 of chemical solution to undergo treatment therewith.

Treating container 51a is provided with treating solution inlets 60, a solution passage 61 and a solution discharge port 62. Thickness (h) of the solution layer is preferably set at 5 mm or less, especially 1 mm or less. The internal volume of the treating container (the portion occupied by the solution which contributes to the plating treatment, pretreatment and after-treatment, not including the rise-up portion at the end of the solution layer in FIG. 4) is 150 cm³ or less, preferably about 20 to 70 cm³.

In case this chemical solution treatment is plating, an electric heating element 58 such as a heater is built in the opposite wall (viz. bottom surface of the treating container) for controlling the temperature, and the temperature in the plating space is measured and controlled. If air gets into the plating solution, the progress of plating reaction is retarded, so that the plating space is preferably filled with an inert gas such as nitrogen or argon or reduced in pressure. It is also effective to introduce nitrogen gas or argon gas into the chemical solution tank containing the plating solution and shut off air to hinder dissolution of oxygen into the solution. Particularly vacuum degassing of the plating solution supplied to the plating container 51a is recommended as it does not affect the quality of the plating film.

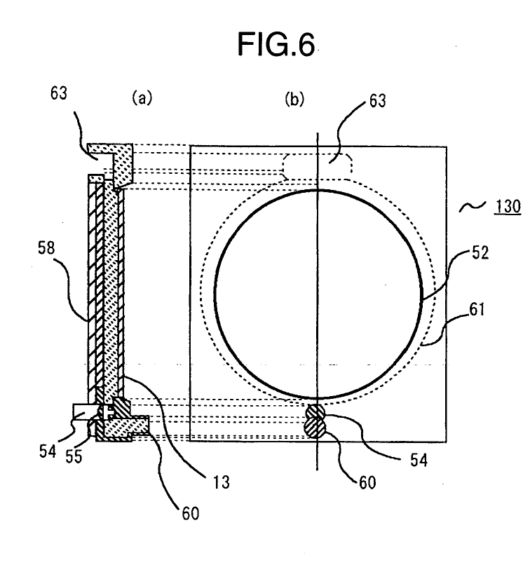

The plating container, or chemical solution treating tank 51 for conducting the plating treatment, is provided in plating stage 29. Two or more of such plating tank may be provided in this stage. Instead of the horizontal treating tank illustrated, it is also possible to use a vertical treating tank 130 such as shown in FIGS. 6(a) and (b). Plating tank 51 shown in FIGS. 6(a) and (b) is erected almost vertically. The thin layer of the chemical solution such as plating solution is formed almost vertically, and the surface to be plated of the wafer is held vertically and brought into contact with the layer of the chemical solution. In FIGS. 6(a) and (b), the same reference numerals as used in FIG. 4 and FIGS. 5(a) and (b) designate the same elements.

In the embodiment of FIGS. 4 and 5, the chemical solution layer is formed substantially horizontally. Although the chemical solution layer may be formed non-horizontally as in FIG. 6, it is more rational and advantageous in terms of ease of treatment to form and hold the solution layer substantially horizontally.

The material composing the plating tank is preferably selected from those which are resistant to high temperature of up to 80° C. and alkalinity. For example, materials with excellent chemical resistance such as Teflon (registered trade mark), heat-resistant vinyl chloride and the like are suited for use as tank material. When higher mechanical strength is required of the plating tank, it is suggested to use a metallic material coated with a highly chemically resistant substance such as Teflon. In this case, it should be noted that if a metal active to the electroless plating reaction is left exposed, the plating reaction advances locally, so that care should be taken to eliminate any exposure of metal.

The plating chamber where electroless plating is carried out is preferably designed so that the distance therefrom to the opposite wall 59 is from 10 μm to 5 mm to lessen the volume of the plating space defined by the object to be plated and said opposite wall 59. By thus restricting the volume of the plating space, it is possible to reduce the amount of the plating solution required for one round of plating operation and to facilitate control of the plating solution such as temperature control. Further, it is possible to shorten the time required for the replacement of the treating solution and to correctly set the time for the plating operation.

The plating solution may be discarded after used once. The electroless plating reaction causes deposition of the metallic components while consuming the reducer components in the plating solution, and induces grdual accumulation of the oxidized product of the reducing agent, so that the respective ionic components in the plating solution are varied in accordance with the progress of the plating reaction. Since the once used solution is discarded, control of the plating solution such as compositional analysis of the solution becomes unnecessary or is remarkably simplified.

Arrangement of the equipment is horizontal in FIG. 4 but not limited to this form; it may be vertical or skewed. Horizontal arrangement has the advantage in that it allows easy control of the plating time since the period of time in which the plating solution is kept in contact with the entirety surface of the wafer can be easily controlled. Vertical arrangement is advantageous in that feed and discharge of the plating solution is easy.

Opposite wall 59 is disposed parallel to wafer 13 in FIG. 4, but it may be set non-parallel to the wafer. Non-parallel arrangement of opposite wall 59 and wafer 13 facilitates feed and discharge of the plating solution. In the opposite wall may be formed grooves for controlling flow of the solution. This can uniformize the mode of hitting of the plating solution against the wafer.

The electroless plating solution is divided into two or more portions and stored in the respective reservoir tanks. Immediately before entering the plating chamber, the plating solution is mixed with a solution containing metallic ions and a solution containing a reducing agent to prevent the self-decomposition reaction from occurring in the plating solution, thereby solving the problem of formation of fine particles in the plating solution and their adhesion to the substrate.

Mixing of the plating solution may be effected by a blender provided in the piping or may be performed in a pre-plating chamber provided for the adjustment of the plating solution. Also, there may be provided the reservoir tanks and corresponding piping for the pre-cleaning solution and the after-cleaning solution, respectively, making arrangement to allow replacement of the solution in the plating tank. This can dispense with the pretreatment tank to contribute to the miniaturization of the equipment. Further, in order to perform cleaning of wafers with an organic solvent or such, it is advisable to install exclusive piping and waste solution discharge line.

Still further, provision of a pure water line for cleaning of the tank and drain for waste acids will facilitate maintenance of the plating tank. A heating means such as electric heater and a temperature control unit are provided for conducting preliminary heating in the reservoir tanks so that the plating solution will have an optimal temperature for plating when it enters the plating chamber.

B. Operation of the Device

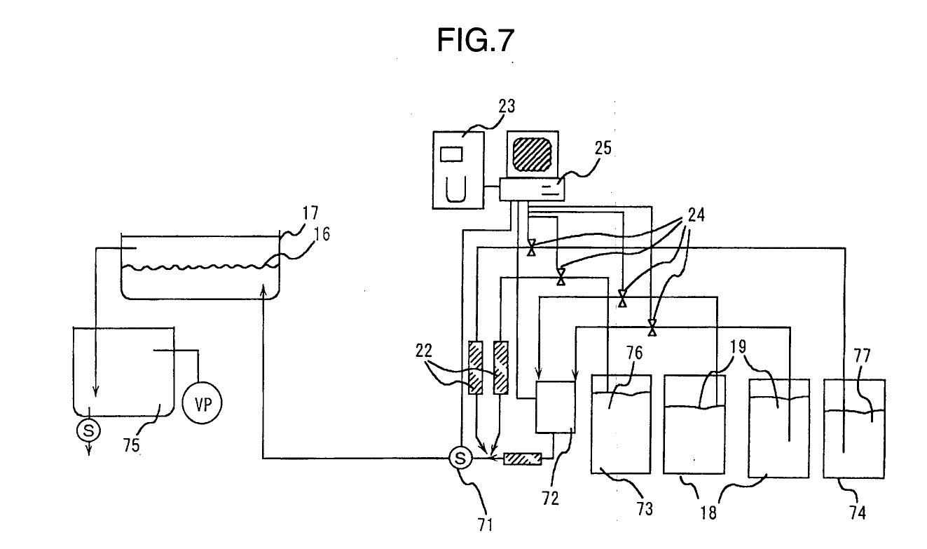

Here, the process of treatments by the plating device in the embodiments of the present invention is described with reference to FIG. 7. The treatments described below are controlled by information processor for control 25. This information processor 25 is a system comprising central processing unit (CPU), main memory, external memory and input-output device. In the following embodiments, processing by this information processor 25 is once stored in a memory medium such as optical disc, magnetic disc or magneto-optical disc, and actualized as the program written in the main memory is executed by CPU, but the present invention is not limited to the actualization means according to such a program.

In the system of FIG. 7, plating solution 16 in plating tank 17 having a cover is degassed by vacuum pump VP. Pretreatment solution 76 in plating pretreatment solution tank 73 is supplied to the plating tank 17 via electromagnetic valve 24. Electroless plating solution is blended in the blender 72 with predetermined amount of the solution 19 from the tank 18. After adjusted with pure water, if needed, the electroless plating solution is supplied into the tank 17 via electromagnetic valve 24, while pure water 77 in pure water tank 74 is supplied via electromagnetic valve and filter 22 and mixed with the plating solution components, and the mixed solution is forwarded into plating solution tank 17.

First, conveyor robot 26 shown in FIG. 2 takes out waters 13 one by one from wafer feed cassette 33 set on loading stage 27, conveys the taken-out wafer to pre-plating stage 28 and places it in plating pretreatment tank 34. Plating pretreatment is conducted on wafer 13 in said tank 34. Then wafer 13 is further carried to plating stage 29 by robot 26 and set to the supporting portion of plating tank 35. A plating film is formed in this plating tank 35.

Wafer 13 is then conveyed to cleaning stage 30 by robot 26, and after undergoing the cleaning and drying treatments, it is taken in recovery cassette 38 at unloading stage 32. If arrangement is made such that wafer 13 is taken in cassette 38 and this cassette 38 is unloaded at drying stage 31, the device can be reduced in size.

The plating procedure at plating stage 29 is explained with reference to FIGS. 2 and 7. By the operation of information processor for control 25, wafer 13 which has undergone plating pretreatment at pre-plating stage 28 is conveyed to plating stage 29 by conveyor robot 26 and set to the wafer support at the opening of the plating tank. Wafer 3 is secured to the support by wafer holder 9 to inhibit the plating solution 16 from getting round to the non-plated side of the wafer, and then inflow of the treating solution into plating tank 35 is started.

Information processor 25 also operates to beforehand heat the reservoir tanks of the plating pretreatment solution and the plating solution and control them at an optimal temperature, and before the plating solution is led into the plating tank, appropriate amounts of the solutions from the respective reservoir tanks are blended and supplied to plating tank 35.

The plating pretreatment solution is thus stored in plating tank 35, and wafer 13, which is the object to be plated, is brought into contact with the plating pretreatment solution. On completion of fill-up of the plating chamber with the treating solution, counting of the treating time is started. After the lapse of a predetermined period of time, the plating solution is led into the plating tank, whereby the pretreatment solution is forced out and replaced with the plating solution. As replacement is completed, supply of the plating solution is ceased, and after the lapse of a certain period of time, for example 2 to 30 minutes, pure water is introduced.

Supply and discharge of pure water is continued until cleaning of wafer 3 is completed after the lapse of a predetermined period of time. After completion of cleaning, the plating solution in plating tank 35 is discharged out and wafer 13 is set free and carried to final cleaning stage 30 by robot 26. This completes the plating film forming process.

### EXAMPLE 1

The following example is illustrated with reference to FIG. 1. Elements were formed on a silicon substrate of 200 mm in diameter. On the substrate having sublayer wiring 2b (FIG. 1(a)), a 1 μm thick SiO₂ insulating film 4 was formed (FIG. 1(b)). Then grooves 7 for wiring and connecting holes 10 were formed by conventional dry etching (FIG. 1(c)). The grooves were 0.2 μm wide and the connecting holes were 0.15 μm in diameter. Then a 50 nm thick Ta film was formed as barrier film 3 by sputtering (FIG. 1(d)), after which a 150 nm thick copper film was formed as seed layer 5 (FIG. 1(e)).

The copper seed layer was formed at a rate of 200 to 400 nm/min by a long distance copper sputtering apparatus Ceraus ZX-1000 (Nippon Shinku Gijutsu Co., Ltd.). This substrate was dipped in a plating solution of the following composition and subjected to 5-minute electroplating (6) at a solution temperature of 24° C. and a current density of 1 A/dm² using phosphorus-containing copper as anode electrode.

| (Electroplating conditions) | | |
|---|---|---|
| Copper sulfate | 0.4 | mol/dm³ |
| Sulfuric acid | 2.0 | mol/dm³ |
| Chloride ion | 1.5 × 10⁻³ | mol/dm³ |
| MICROFAV Cu2100 | 10 × 10⁻³ | dm³/dm³ |
| (copper plating additive | | |
| produced by Nippon | | |
| Electroplating Engineers Co., Ltd.) | | |

Then, for separating the metals precipitated by electroplating, chemical machine grinding was carried out by a chemical machine grinder Model 472 mfd. by IPEC Ltd. using alumina-dispersed abrasive grains containing 1 to 2% of hydrogen peroxide and a pad (IC-1000 mfd. by Rodel Corp.). The substrate was ground to the barrier film under a grinding pressure of 190 g/cm² to separate the wiring conductors (FIG. 1(g)).

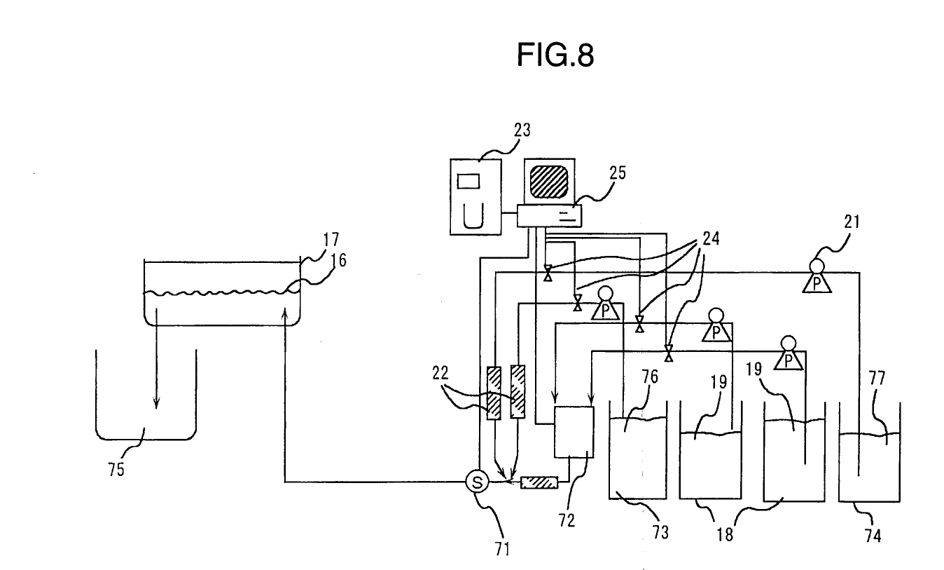

Then, an interconnect protective film was formed by using the electroless plating device shwon in FIG. 4 and the electroless plating system shown in FIG. 8. Connected to the electroless plating device were piping for organic solvent, piping for cleaning with an alkaline solution, piping for electroless plating solution, and piping for water washing. In FIG. 8, the same reference numerals as used in FIG. 7 designate the same elements. No degassing pump is provided in the system of FIG. 8, but the plating solution components are supplied by using pumps P.

The distance between the wafer to be plated and the opposing wall was set at 1 mm. For disposal of the waste solutions, a waste organic solvent discharge line and a waste inorganic solution discharge line were connected. Before conducting plating on the wafer, the alkaline aqueous solution used for pretreatment, the solution containing metal ions used as the plating solution and the solution containing a reducing agent were heated respectively to 55° C., and nitrogen was bubbled through the solutions in the reservoir tanks.

The plating tank and the wafer holder were preheated to 50° C. For cleaning before plating, isopropyl alcohol was introduced at a rate of 750 ml/min, and the supply of the solution was suspended for 3 minutes after the wafer came into contact with the solution. Then the pretreatment solution (alkaline aqueous solution) was introduced for 10 seconds at a rate of 750 ml/min to replace the solution in the tank, and the supply of the solution was suspended for 3 minutes.

Thereafter, the plating solution was introduced for 10 seconds at a rate of 750 ml/min to replace the solution in the tank with the plating solution, then the supply of the solution was suspended for a predetermined period of time and cobalt-based electroless plating was conducted. Then pure water was introduced into the plating tank for one minute for cleaning. Since the reducing agent used here is reacted on copper, the cobalt-based electroless plating reaction proceeds on copper interconnect without a step of catalyzation such as introduction of palladium (FIG. 1(h)).

Since in this devic the plating tank and the wafer holder have been preheated, the temperature distribution in the wafer plane during electroless plating was satisfactorily narrow, with the disparity being 0.5° C. at the most. Also, in this device, diaphragm pumps were employed for the introduction of the solution, and the supply of the solution was stopped after introduction of the treating solution was completed. By stopping the supply of the solution, it was possible to reduce the amount of the plating solution required.

Stirring of the plating solution was effected by moving the plating solution back and forth in the plating chamber and flow passages by idling the diaphragm pumps. Since the volume of the plating chamber was as small as 35 cm³ in this example, it was possible to secure sufficient movement of the plating solution and to improve stirring performance even when the volume of the plunger portion of the pump was 5 cm³.

The plating pretreatment conditions and the plating conditions are shown below.

| (Plating pretreatment solution) | | |
|---|---|---|
| Citric acid | 0.30 | mol/dm³ |
| Dimethylamineborane | 0.06 | mol/dm³ |
| RE610 (surfactant produced | 0.05 | g/dm³ |
| by Toho Chemical Co., Ltd.) | | |
| (Plating pretreatment conditions) | | |
| pH | 9.5 (adjusted with | |
| | tetramethylammonium | |
| | solution) | |
| Solution temperature | 55° C. | |
| Pretreatment time | 3 | min. |
| (Cobalt-based | | |
| electroless plating solution) | | |
| Cobalt sulfate | 0.1 | mol/dm³ |
| Citric acid | 0.3 | mol/dm³ |
| Dimethylamineborane | 0.06 | mol/dm³ |
| Tungstic acid | 0.03 | mol/dm³ |
| RE610 (surfactant produced by | 0.05 | g/dm³ |
| Toho Chemical Co., Ltd.) | | |
| (Plating conditions) | | |
| pH | 9.5 (adjusted with | |
| | tetramethylammonium | |
| | solution) | |
| Solution temperature | 55° C. | |
| Plating time | 2 | min. |

Cobalt-based electroless plating was carried out under the above plating conditions. After cleaning with pure water, wafer 3 was unlocked and conveyed to final cleaning stage 30 by conveyor robot 26. At the final cleaning stage, the wafer was cleaned for 2 minutes by rotating it at 500 rpm by a spinner while spraying pure water against the surface and the rear side of the wafer, then spray of pure water was stopped and the wafer was rotated at 2,000 rpm to scatter away the liquid and thereby dried. Then the wafer was carried to the unloading stage by the conveyor robot. This completed the process of forming a cobalt-based electroless plating film serving as an interconnect protective film.

The thus formed substrate was worked by the focused ion beams (FIB). Observation of a cross section of the substrate including the grooves and holes by a scanning electron microscope (SEM) showed that a 30 nm thick cobalt-tungsten-boron alloy film was deposited uniformly on the copper surface.

No discrepancy in film thickness was noted between the peripheral and central parts of the wafer in the SEM observation of the formed film. Also, no deposition of cobalt-tungsten-boron alloy was seen on the insulating film. Auger electron spectroscopic analysis of the obtained cobalt alloy confirmed that it was an electroless plating film composed of 79 atomic % of cobalt, 20 atomic % of tungsten and 1 atomic % of boron.

From the foregoing, it was confirmed, as the effect of the instant embodiment of the present invention, that an interconnect protective film can be formed uniformly in the wafer plane only on the copper embedded in the wiring grooves and holes by using the plating device according to the described example of the present invention.

Then the thus obtained copper interconnect substrate with a protective film was annealed for 30 minutes by heating to 500° C. in a 2% hydrogen/98% helium gas atmosphere. As a result of Auger electron spectroscopic examination of its surface, no copper was detected from the surface and also no diffusion of copper, or wiring material, was seen. The wiring resistance before and after the heat treatment was not greater than 3% on the entire wafer surface, and it could be confirmed that no increase of wiring resistance was caused by oxidation of copper. Further, as no change of resistance was admitted before and after formation of the interconnect protective film as a result of measurement of inter-wiring resistance, it could be confirmed that no abnormal deposition occurred between wiring.

From the foregoing, it could be confirmed that by using the electroless plating method according to the instant embodiment of the present invention, it is possible to form a cobalt-tungsten-boron alloy film uniformly in the wafer plane as a copper interconnect protective film, to prevent oxidation and diffusion of copper, and to obtain high reliability of the semiconductor devices having copper interconnect.

### EXAMPLE 2

In this example, electroless plating was carried out using a horizontal film plating device 130 similar to that used in Example 1 shown in FIG. 4, with a vacuum pump provided on the treating solution discharge piping as shown in FIG. 7. The composition of the plating solution 16 and the plating conditions were the same as used in Example 1.

Before carrying out plating on the wafers, an alkaline solution used for pretreatment, a solution containing metallic ions used as plating solution, and a solution containing a reducing agent were heated respectively to 55° C., and nitrogen was bubbled into the respective reservoir tanks. The plating tank and the wafer holder were preheated to 50° C. The vacuum chamber was evacuated by a vacuum pump, and the reservoir tanks of the chemical solutions were closed airtight. Then the valve connecting the vacuum chamber and the plating chamber was opened, followed by opening of the valve connecting the pre-cleaning tank and the plating chamber to admit the pre-cleaning fluid into the plating chamber.

For pre-cleaning (cleaning before plating), isopropyl alcohol was introduced at a rate of 600 ml/min, and after the wafer came into contact with the fluid, the valve connecting the plating chamber and the pre-cleaning tank was closed to suspend supply of the fluid for 3 minutes. Then the valve connecting the plating chamber and the plating pretreatment tank was opened to introduce an alkaline aqueous solution as a pretreatment solution at a rate of 600 ml/min for 15 seconds to replace the solution in the tank, followed by suspension of supply of the solution for 3 minutes. Then the plating solution was introduced at a rate of 600 ml/min for 15 seconds to replace the solution in the tank with the plating solution, after which supply of the solution was stopped for a predetermined period of time and cobalt-based electroless plating was conducted.

Thus by introducing the solution in a depressurized state, it was possible to prevent the air bubbles produced in the plating solution or the bubbles of the surfactant from adhering to the wafer surface, thereby inhibiting the possibility of non-deposition of the plating film due to adhesion of air bubbles. Then pure water was introduced into the plating tank for one minute for cleaning. Stirring of the plating solution in this device was effected by moving the plating solution back and forth in the plating chamber and the flow passages by opening and closing the valve of the vacuum chamber.

Cobalt-based electroless plating was carried out under the said plating conditions, followed by cleaning with pure water, and then wafer 13 was unlocked and conveyed to final cleaning stage 30 by robot 26. At the final cleaning stage, the wafer was cleaned for 2 minutes by rotating it at 500 rpm by a spinner while spraying pure water to the surface and rear side of the wafer. Then spray of pure water was stopped, and the wafer was rotated at 2,000 rpm to scatter away the liquid to dry the wafer. The wafer was then further conveyed to the unloading stage by the convenyor robot, thereby completing the process of forming a cobalt-based electroless plating film used as an interconnect protective film.

The thus formed substrate was worked by FIB. SEM observation of its cross section including the grooves and holes showed that a 30 nm thick cobalt-tungsten-boron alloy film was uniformly deposited on the copper surface. Also, as a result of observation of the formed film, there was admitted no discrepancy in film thickness between the peripheral part and the central part of the wafer, and no non-deposition area existed. Further, no deposition of cobalt-tungsten-boron alloy was noted on the insulating film.

Auger electron spectroscopic analysis of the obtained cobalt alloy confirmed that it was an electroless plating film composed of 79 atomic % of cobalt, 20 atomic % of tungsten and 1 atomic % of boron.

From the foregoing, it was confirmed that an interconnect protective film can be formed uniformly in the wafer plane only on the copper embedded in the wiring grooves and holes by using the plating device according to the instant embodiment of the present invention.

Then the thus formed copper interconnect substrate with a protective film was subjected to 30-minute annealing by heating to 500° C. in a 2% hydrogen/98% helium gas atmosphere. As a result of Auger electron spectroscopic examination of its surface, no copper was detected from the surface and also no diffusion of copper (wiring material) was seen. The wiring resistance before and after the heat treatment was not greater than 2% on the entire wafer surface, from which it could be confirmed that there took place no increase of wiring resistance due to oxidation of copper.

Further, as no change of resistance was admitted before and after formation of the interconnect protective film as a result of measurement of inter-wiring resistance, it could be confirmed that no abnormal deposition occurred between wiring.

From the foregoing, it could be confirmed that by using the electroless plating method according to the instant embodiment of the present invention, it is possible to form a cobalt-tungsten-boron alloy film uniformly in the wafer plane as a copper interconnect protective film, to prevent oxidation and diffusion of copper, and to obtain high reliability of the semiconductor devices having copper interconnect.

### EXAMPLE 3

In this example, a vertical film plating device 130 illustrated in FIG. 6 was used. The composition of the plating solution 16 and the plating conditions were the same as used in Example 1. In the plating device of this example, a vertical plating tank was used, and the solution was pumped into the tank from its bottom.

Connected to the plating device were piping for organic solvent, piping for cleaning with an alkaline aqueous solution, piping for electroless plating solution and piping for water washing. The distance between the wafer to be plated and the opposing wall was set at 1 mm. For discharge of waste solution, a waste organic solvent discharge line and a waste inorganic aqueous solution discharge line were connected to the device. Isopropyl alcohol was introduced at a rate of 750 ml/min for pre-cleaning. After the wafer came into contact with the fluid, the three-way valve connecting the plating chamber and pre-cleaning tank was closed to suspend supply of the fluid for 3 minutes.

Thereafter, the plating chamber and the discharge port were connected by using the three-way valve to discharge the pre-cleaning fluid, and then the three-way valve was converted to a flow inlet. A pretreatment solution comprising an alkaline aqueous solution was introduced at a rate of 750 ml/min for 5 seconds, and after the tank was filled up with the pretreatment solution, supply of the solution was suspended for 3 minutes. Then the plating chamber and the discharge port were connected by the three-way valve to discharge the pretreatment solution, and then the three-way valve was converted to a flow inlet through which the plating solution was introduced at a rate of 750 ml/min for 5 seconds. After the tank was filled with the plating solution, supply of the solution was suspended for a predetermined period of time and cobalt-based electroless plating was carried out.

Then pure water was introduced into the plating tank for one minute for cleaning the tank. Stirring of the plating solution in this device was effected by moving the plating solution back and forth in the plating chamber and flow passages by a diaphragm pump as in Example 1. This was followed by cleaning and drying in the same manner as in Example 1 to complete the process of forming a cobalt-based electroless plating film serving as an interconnect protective film. In this example, because of use of a vertical tank, discharge of the treating solution was easy and could be completed in about 2 seconds.

The thus formed substrate was worked by FIB, and its cross section including the grooves and holes was observed by SEM, which showed that a 25 nm thick cobalt-tungsten-boron alloy film was deposited uniformly on the copper surface. As a result of observation of the film formed at the upper, central and lower parts of the wafer, it was found that the film deposition was approximately 4% thicker at the lower part than at the central part due to the difference in time required for the introduction and discharge of the plating solution, but scatter of film thickness was less than 5% in the entire wafer. No deposition of the cobalt-tungsten-boron alloy on the insulating film was admitted.

Auger electron spectroscopic analysis of the obtained cobalt alloy film confirmed that it was an electroless plating film composed of 79 atomic % of cobalt, 20 atomic % of tungsten and 1 atomic % of boron.

The foregoing results confirmed the effect of this embodiment that an interconnect protective film can be formed uniformly in the wafer plane only on the copper embedded in the wiring grooves and holes by using the plating device according to the instant embodiment of the present invention.

Then the thus obtained copper inter-connect substrate with a protective film was subjected to 30-minute annealing by heating to 500° C. in a 2% hydrogen/98% helium gas atmosphere. In the Auger electron spectroscopic examination of its surface, there was detected no copper from the surface nor was observed any diffusion of copper as wiring material. Wiring resistance before and after the heat treatment was less than 2% in the entire wafer, which confirmed that no increase of wiring resistance attributable to oxidation of copper took place. Also, since no change of resistance was admitted before and after formation of the interconnect protective film in the measurement of inter-wiring resistance, it was ascertained that no abnormal deposition occurred between wiring.

From the foregoing, it was confirmed that by using the electroless plating method according to the instant embodiment of the present invention, it is possible to form a cobalt-tungsten-boron alloy film uniformly in the wafer plane as a copper interconnect protective film, to prevent oxidation and diffusion of copper, and to obtain high reliability of the semiconductor devices having copper interconnect.

### EXAMPLE 4

In this example, instead of forming a cobalt-tungsten-boron alloy film, a cobalt-tungsten-phosphorus alloy film was formed on the copper interconnect by the electroless plating method of the present invention.

Copper interconnect was formed on a silicon substrate in the same way as in Example 1. Since hypophosphorous acid is used as reducing agent in cobalt-tungsten-phosphorus plating, no direct reaction takes place on the copper, so that no direct plating on the copper is possible. For carrying out plating in this case, it is necessary to beforehand apply a catalyst 9 such as palladium on the copper. Since the plating chamber is contaminated if the palladium treatment is conducted in the plating chamber, the following palladium catalyzation step was carried out at the pre-plating stage.

| (Palladium catalyzation step) | | |
|---|---|---|
| Palladium chloride | 0.003 | mol/dm³ |
| Hydrochloric acid | 1 × 10⁻³ | dm³/dm³ |
| Acetic acid | 0.5 | dm³/dm³ |
| Hydrofluoric acid | 5 × 10⁻³ | dm³/dm³ |

| | |
|---|---|
| Temperature | 24° C. |
| Time | 10 seconds |

By the catalyzation treatment, palladium was deposited on the islet with an average size of 20 nm. After washing with pure water for one minute, the wafer was transferred to the plating stage by a robot. Then electroless plating was carried out with the same process as used in Example 1. The electroless plating solution used is shown below.

| (Electroless plating solution) | | |
|---|---|---|
| Cobalt sulfate | 0.1 | mol/dm³ |
| Citric acid | 0.3 | mol/dm³ |
| Hypophosphorous acid | 0.2 | mol/dm³ |
| Tungstic acid | 0.03 | mol/dm³ |
| RE610 (surfactant produced by | 0.05 | g/dm³ |
| Toyo Chemical Co., Ltd.) | | |
| (Plating conditions) | | |
| pH | 9.5 (adjusted | |
| | with tetramethyl- | |
| | ammonium solution) | |
| Solution temperature | 75° C. | |
| Plating time | 5 | min. |

Cobalt-based electroless plating was carried out under the above plating conditions, and after washing with pure water, wafer 3 was unloosed and conveyed to final cleaning stage 30 by conveyor robot 26. At the final cleaning stage, the wafer was cleaned for 2 minutes by rotating it at 500 rpm by a spinner while spraying pure water over the surface and the rear side of the wafer, then spray of pure water was stopped and the wafer was rotated at 2,000 rpm to scatter away the liquid to dry the wafer. Then the wafer was carried to the unloading stage by a conveyor robot, completing the process of forming a cobalt-based electroless plating film as an interconnect protective film.

SEM observation of a cross section of the obtained substrate showed that a cobalt-tungsten-phosphorus alloy plating film was selectively deposited as shown in FIG. 9. Also, as a result of similar SEM observation, it was found that, as shown in FIG. 10, beside interconnect protective film 1 deposited on the copper interconnect pattern, there existed abnormal deposits 63 between wiring and inter-wiring shorting 64, at 5 spots in all in the wafer, but an interconnect protective film was formed selectively on other part.

Cross-sectional observation of the FIB-worked wafer showed that the copper interconnect surface was enlarged in unevenness due to replacement with palladium, and that a uniform interconnect protective film was formed, with the film thickness at the center and periphery of the wafer being 35 nm.

Auger electron spectroscopic analysis of the obtained cobalt alloy film showed that it was an electroless plating film composed of 84 atomic % of cobalt, 8 atomic % of tungsten and 8 atomic % of phosphorus.

From the foregoing, it was confirmed that by using the plating device according to the instant embodiment of the present invention, it is possible to form an interconnect protective film uniformly in the wafer plane only on the copper embedded in the wiring grooves and holes.

Then the produced copper interconnect substrate with a protective film was subjected to 30-minute annealing by heating to 400° C. in a 2% hydrogen/98% helium gas atmosphere. In Auger electron spectroscopic examination of its surface, there was detected no copper from the surface nor was admitted any diffusion of wiring copper. Wiring resistance before and after the heat treatment was less than 6% on the entire wafer surface, which confirmed that there took place no rise of wiring resistance due to oxidation of copper.

Further, as a result of measurement of inter-wiring resistance, there was admitted no change of resistance before and after formation of the interconnect protective film, excepting the 7 spots in the wafer where a notable decrease of inter-wiring resistance occurred, from which it was confirmed that no abnormal deposition took place between wiring except for the above 7 spots.

The foregoing endorses the fact that by using the electroless plating method in the instant embodiment of the present invention, it is possible to form a cobalt-tungsten-phosphorus alloy film uniformly in the wafer plane as a copper interconnect protective film, to prevent oxidation and diffusion of copper, and to obtain high reliability of the semiconductor devices having copper interconnect.

### EXAMPLE 5

This example is identical with Example 1 except for use of an organic insulating material for the inter-wiring insulating film and the step of forming such an insulating film.

Elements were formed on a 200 mm-diameter silicon substrate, and an organic insulating film with a low dielectric constant was formed on the substrate having sublayer wiring. For forming said organic insulating film, a hydrocarbon (including aromatic hydrocarbon)-based organic insulating film material with a low dielectric constant was spin coated to a thickness of 300 nm on the substrate and cured by a 30-minute, 400° C. heat treatment in a nitrogen (N₂) atmosphere. A typical example of the hydrocarbon (including aromatic hydrocarbon)-based organic insulating film materials with a low dielectric constant usable here is commercially available under the trade name of “SiLK” from Dow Chemical Co., Ltd., which has a dielectric constant of approximately 2.65.

Although in this example “SiLK” was used as the low dielectric constant organic insulating film material, it is possible to use other known organic insulating film materials such as, for example, “BCB” available from Dow Chemical Co., Ltd., “FLARE” available from Allied Signal Co., Ltd., and “VELOX” available from Schumacher Co., Ltd.

Then, after ordinary patterning and formation of grooves 7 for wiring and connecting holes 10, copper interconnect was formed on the silicon substrate in the same way as in Example 1, followed by cobalt-based electroless plating thereon to form a cobalt-tungsten-boron film.

The thus formed substrate was worked by FIB, and its cross section including the grooves and holes was observed by SEM, which showed that an 180 nm thick cobalt-tungsten-boron alloy film was deposited uniformly on the copper surface. No deposition of cobalt-tungsten-boron alloy was observed on the organic insulating film. Auger electron spectroscopic analysis of the obtained cobalt alloy film confirmed that it was an electroless plating film composed of 79 atomic % of cobalt, 20 atomic % of tungsten and 1 atomic % of boron.

From the foregoing, it was confirmed that when using an organic insulating film in this embodiment of the present invention, it is possible to form an interconnect protective film only on the copper embedded in the wiring grooves and holes by the electroless plating method of this invention.

Then the obtained copper interconnect substrate having a protective film was subjected to 30-minute annealing by heating to 400° C., 450° C. and 500° C. in a 2% hydrogen/98% helium gas atmosphere. In Auger electron spectroscopic observation of the surface of each substrate, no copper was detected from the surface nor diffusion of wiring copper was admitted in any of the substrates treated at 400° C., 450° C. and 500° C. Also, there was seen no change of wiring resistance before and after the heat treatment at 500° C., from which it was confirmed that there took place no rise of wiring resistance due to oxidation of copper.

From the above, it was confirmed that even when using an organic insulating film with a low dielectric constant as the inter-wiring insulating film, it is possible to form a cobalt-tungsten-boron alloy film selectively on the copper as a copper interconnect protective film in the same way as in Example 1, to prevent diffusion of copper, and to secure reliability of wiring.

Shown below are the important embodiments of the present invention. These embodiments are implemented in conjunction with the inventive concepts set forth in the appended Claims.
(1) An electroless plating method according to any one of the Claims wherein plural treating solutions are introduced successively, either before or after the electroless plating treatment, to the surface to be plated of the substrate to be worked.
(2) An electroless plating method according to any one of the Claims wherein the components of the electroless plating solution are prepared as the respective chemical solutions and reserved in the respective chemical solution tanks, then these chemical solutions are mixed in the introduction passage to form a plating solution, and this plating solution with its components adjusted is introduced to the area where electroless plating is to be conducted.
(3) An electroless plating method according to any one of the Claims wherein before conducting electroless plating, a pretreatment is carried out with a pretreatment solution at least adjusted in pH by a reducing agent, a complexing agent and an organic alkali.
(4) An electroless plating method according to any one of the Claims wherein a boron compound or an aldehyde is used as the reducing agent for the pretreatment solution.
(5) An electroless plating method according to any one of the Claims wherein the layer of said plating solution is maintained non-horizontally, and the area to be plated is brought into contact with the surface of said plating solution.
(6) An electroless plating method according to any one of the Claims wherein the thickness of the layer of said electroless plating solution is 0.05 to 3 mm.
(7) An electroless plating method according to any one of the Claims wherein the thickness of the layer of said electroless plating solution is 0.1 to 1 mm.
(8) An electroless plating method according to any one of the Claims wherein said electroless plating solution and the area to be plated are kept in contact during the period until the deposit thickness becomes 5 to 100 nm.
(9) An electroless plating method according to any one of the Claims wherein the electroless plating solution and the surface to be plated of the substrate are brought into contact with each other so that a deposit thickness of 10 to 60 nm will be obtained.
(10) An electroless plating method according to any one of the Claims wherein said electroless plating operation is conducted on each of said substrates respectively, and the amount of the electroless plating solution used per substrate is 10 to 100 ml.
(11) An electroless plating method according to any one of the Claims wherein said electroless plating operation is conducted on each of said substrates respectively, and the amount of the electroless plating solution used per substrate is 20 to 70 ml.
(12) An electroless plating method according to any one of the Claims wherein said electroless plating operation is conducted on each of said substrates respectively, and the amount of the electroless plating solution used per substrate is 30 to 50 ml.
(13) An electroless plating device according to any one of the Claims wherein piping is provided for supplying the different treating solutions successively into the electroless plating container.
(14) An electroless plating device according to any one of the Claims wherein means are provided for holding the substrate to be plated so that it will be positioned non-horizontally and that the surface to be plated of the substrate will face downwardly so that it will contact the surface of the plating solution.
(15) An electroless plating device according to any one of the Claims wherein a thin layer of the electroless plating solution is formed between the underside of the electroless plating container and the surface to be plated of the substrate to be worked.
(16) An electroless plating program for executing electroless plating described in any one of the Claims whereby a computer used for the electroless plating method for forming an interconnect protective film on the copper interconnect surface of a semiconductor substrate is operated to function as a means for introducing an appropriate amount of the treating solution into the plating space, a means for controlling the temperature of the heating device for maintaining the treating solution at a predetermined temperature, and a means for discharging the treating solution after the lapse of a predetermined period of time.
(17) An electroless plating program for executing electroless plating described in any one of the Claims wherein the computer functions as a means for mixing the plural chemical solutions each in an appropriate amount to prepare a treating solution and introducing it into the plating space.
(18) An electroless plating program for executing electroless plating described in any one of the Claims wherein the computer functions as a means for properly introducing the plural treating solutions to replace the treating solution in the plating space.
(19) A memory medium readable by a computer characterized in that it maintains the electroless plating program described in any one of the Claims.

It should be further understood by those skilled in the art that although the foregoing description has been made on embodiments of the invention, the invention is not limited thereto and various changes and modifications may be made without departing from the spirit of the invention and the scope of the appended claims.

Effect of the Invention

According to the present invention, a high-quality electroless plating film can be obtained with stability. Also, according to the present invention, a high-quality protective film for wiring of semiconductor devices can be produced with ease.

1. An electroless plating method comprising the step of carrying out an electroless plating treatment by, while keeping an electroless plating solution beforehand prepared at a continuous thin liquid layer, bringing a surface to be plated of a substrate, on which an electroless plating is to be formed, into contact with the liquid layer and by maintaining the contacting state for a prescribed period of time.

2. The method according to claim 1 wherein, in the electroless plating treatment step, the electroless plating solution is exposed to a depressurized atmosphere to decrease gas components staying dissolved in the solution.

3. The method according to claim 1 wherein said electroless plating treatment is conducted on each of the substrates piece by piece, and an amount of the electroless plating solution used per substrate is 5 to 150 ml.

4. The method according to claim 1 wherein the electroless plating solution, at least in a region where the electroless plating is to be conducted, is kept in a substantially closed atmosphere shut off from an outer air.

5. The method according to claim 1 wherein the layer of the plating solution is kept in a non-oxidizing atmosphere.

6. The method according to claim 1 wherein the liquid layer of the solution is substantially kept horizontally, and a downward facing surface to be plated of the substrate is brought into contact with the surface of the plating solution.

7. The method according to claim 1 wherein the surface to be plated has a copper interconnect, and an interconnect protective film is formed on said copper interconnect by said electroless plating.

8. The method according to claim 4 wherein the electroless plating treatment is carried out in a nitrogen gas or argon gas atmosphere.

9. The method according to claim 1 wherein, at least during the electroless plating treatment, an opening of a container forming the layer of the electroless plating solution is closed by the surface to be plated of the substrate.

10. The method according to claim 1 wherein a thickness of the layer of the electroless plating solution is 0.01 to 5 mm.

11. The method according to claim 1 wherein a flow of the electroless plating solution is stopped during the electroless plating treatment.

12. An electroless plating device comprising:
an electroless plating treatment container having an opening and forming a continuous thin liquid layer of the electroless plating solution;
a means for feeding the electroless plating solution to said electroless plating treatment container; and
a degassing means for lowering a gas in the electroless plating solution.

13. The electroless plating device according to claim 12 wherein an internal capacity of the electroless plating container is 5 to 150 ml.

14. The electroless plating device according to claim 12 wherein an area of the opening of the electroless plating treatment container is larger than an area of the surface to be plated of the substrate to be plated, and said opening and said substrate to be plated are arranged so that said opening be closed by said substrate.

15. The electroless plating device according to claim 12 wherein the distance between the surface to be plated of the substrate and a bottom side of the electroless plating treatment container is 0.01 to 5 mm.

16. The electroless plating device according to claim 12 wherein means are provided for keeping the thin layer of the electroless plating solution substantially horizontally and for holding the surface to be plated of the substrate in a downwardly facing position to contact the thin layer of the plating solution.

17. The electroless plating device according to claim 12 wherein in addition to a tank of the electroless plating solution, there is provided at least one kind of treating solution tank.

18. The electroless plating device according to claim 12, further comprising a gas supply pipe for substituting a space of the electroless plating treatment container with an inert gas atmosphere lowered in oxygen concentration.

19. A method for producing a semiconductor device comprising the steps of:
holding a semiconductor substrate so as to bring a region, at which an interconnect protective film on the semiconductor substrate having a metal interconnect is to be formed, into contact with a thin layer of an electroless plating solution beforehand prepared;
degassing the electroless plating solution to decrease gas components therein; and
conducting an electroless plating treatment while shutting off an atmosphere of the electroless plating solution from an outer air to form the interconnect protective film.

20. A device for producing a semiconductor device comprising:
means for setting a region, at which an interconnect protective film on a semiconductor substrate having a metal interconnect is to be formed, and for holding said semiconductor substrate so as to bring said region of the substrate into contact with a thin layer of an electroless plating solution beforehand prepared;
a degassing means for degassing the plating solution to decrease gas components therein; and
a closure means for shutting off an atmosphere of the electroless plating solution from an outer air.
